(19) United States
(12) Patent Application Publication
(10) Pub. No.: US 2013/0125378 A1
(43) Pub. Date: May 23, 2013

(54) Leg Rest Release Assembly and Method of Assembling the Same

(71) Applicant: Emily Hannah Berman, Lombard, IL (US)

(72) Inventor: Emily Hannah Berman, Lombard, IL (US)

(21) Appl. No.: 13/304,285

(22) Filed: Nov. 23, 2011

(51) Int. Cl. F16B 7/18; B23P 11/00

(52) U.S. Cl. 29/525.11; 403/343

(57) ABSTRACT

A mechanical retention apparatus suitable for serving as a leg rest release for a wheelchair is provided. The mechanical retention apparatus includes a first cylindrical housing (306) and a second cylindrical housing (304). The first cylindrical housing (306) has interior threads (413), while the second cylindrical housing (304) has a threaded end (313) that is complementary with the internal threads such that the internal threads and the threaded end can engage to form a nested cylindrical housing assembly (311). A unitary shaft-stem assembly (310) includes a push-button (301), a stem (303), and a shaft (302). The shaft (302) can be perdurably connected to the push-button (301) to prevent separation. An axial length (402) of the nested cylindrical housing assembly (311) can be adjusted by rotating the first cylindrical housing (306) relative to the second cylindrical housing (304).

### BACKGROUND

1. Technical Field

This invention relates generally to mechanical devices, and more particularly to a device for selectively attaching a leg rest to a wheelchair.

2. Background Art

Many wheelchairs come with detachable leg and foot rests. To remove a leg rest, a user presses a push-button of a mechanical assembly, which causes a shaft to move laterally along an axis, thereby releasing the leg rest from the wheelchair. The problem with prior art leg rest releases is that the shaft is threaded into the push-button. Repeated use of the push button causes the shaft to unscrew. Once the shaft unscrews, the entire mechanical assembly is rendered inoperative. Accordingly, the leg rests cannot be secured to the wheelchair. As these devices are not replaceable, the entire wheelchair must be replaced.

It would be advantageous to have a more reliable leg rest release.

### BRIEF DESCRIPTION OF THE DRAWINGS

FIGS. 1 and 2 illustrates a prior art mechanical assembly for coupling a leg rest to a wheelchair.

FIG. 3 illustrates an exploded view of one explanatory leg rest release configured in accordance with one or more embodiments of the invention.

FIG. 4 illustrates one explanatory housing assembly for a leg rest release configured in accordance with one or more embodiments of the invention.

FIG. 5 illustrates an explanatory method of assembling a leg rest release in accordance with one or more embodiments of the invention.

FIGS. 6-9 illustrate a variety of plunger assemblies having different stems, each suitable for use in a leg rest release configured in accordance with one or more embodiments of the invention.

FIG. 10 illustrates an alternate assembling step for a leg rest having an alternate stem configured in accordance with one embodiment of the invention.

FIG. 11 illustrates a leg rest release configured in accordance with one or more embodiments of the invention being used to securely couple a leg rest to a wheelchair.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF EMBODIMENTS OF THE INVENTION

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide a release mechanism for use in wheelchairs that offers a far more reliable construction when compared to prior art designs. A shaft-stem assembly is integrally formed with a push-button as a unified component. The shaft-stem assembly is then disposed within a central axis of two cylindrical housings. The cylindrical housings have different diameters, with one being smaller than the other, so that they may couple together in a nested configuration. In one embodiment, the cylindrical housings are threaded such that an overall length of the nested cylindrical housings can be adjusted by rotating one cylindrical housing relative to the other. Embodiments of the present invention do not use a threaded coupling between push-button and shaft. For this reason, the problem of the shaft unscrewing during use, which is present in prior art designs, is obviated in embodiments of the present invention.

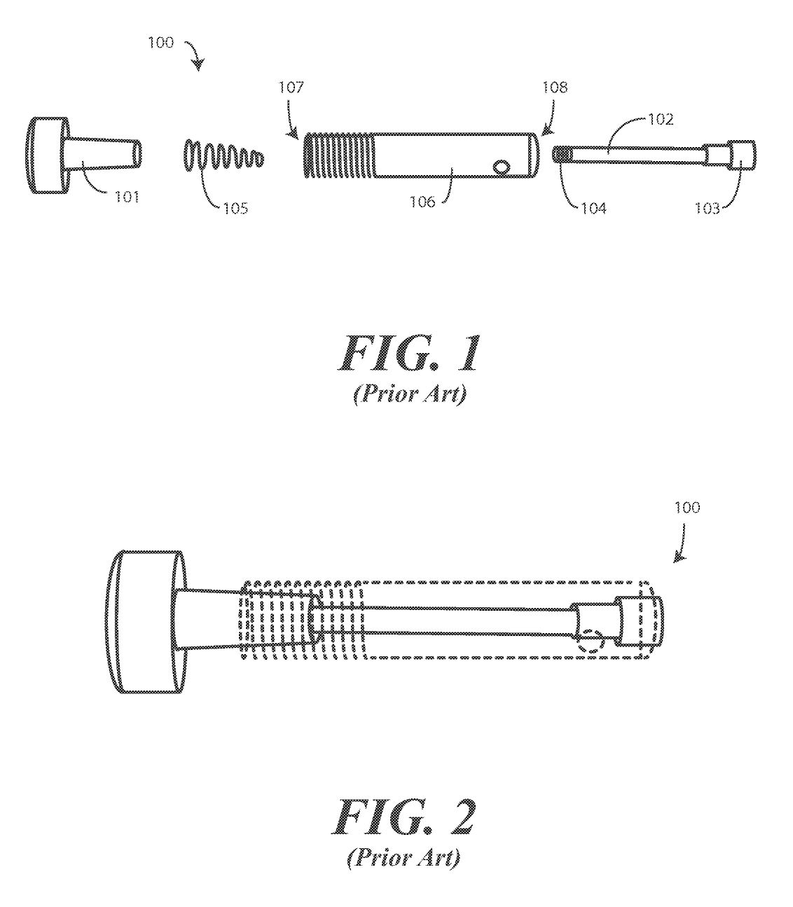

Beginning with FIG. 1, illustrated therein is a prior art mechanical assembly 100 used to selectively couple the leg rest of a wheelchair to the wheelchair itself. The prior art mechanical assembly 100 includes a push-button 101, a shaft 102, and a stair-stepped stem 103. The shaft 102 screws into the push-button 101 via threads 104 disposed at a distal end of the shaft 102 relative to the stair-stepped stem 103. A spring 105 biases the push-button 101 outward from a cylindrical member 106.

To assemble the mechanical assembly 100, one first inserts the spring 105 into the cylindrical member 106. One then inserts the push-button 101 into a first end 107 of the cylindrical member 106. Next, the shaft 102 is inserted into an opposite end 108 of the cylindrical member 106. The threads 104 of the shaft 102 are then screwed into the push-button 101 by rotating the shaft 102, the push-button 101, or both. Prior art designs require the shaft 102 to thread into the push-button so that the length of the push-button-shaft assembly can be adjusted to properly align with a ball-bearing release mechanism (not shown). Without the threaded push-button-shaft assembly, the prior art design cannot be reliably manufactured. The completed mechanical assembly 100 is shown in a ghost view in FIG. 2.

The problem with the design of FIGS. 1 and 2 is that the shaft 102 has a tendency to unscrew a little bit each time the push-button 101 is pressed. As the mechanical assembly 100 is oriented in a vertical position with the push-button 101 atop the shaft 102 when in use, when the shaft 102 completely unscrews it falls out due to the force of gravity. The shaft 102 is frequently lost as it generally bounces or rolls along the ground. Replacement shafts are not available. Consequently, a user who experiences this situation must replace the entire wheelchair. The cost of doing this can be high, and is generally on the order of several hundred dollars.

To remedy this problem, embodiments of the present invention employ a shaft-stem assembly that is integrally formed with the push-button as a unitary component. Accordingly, the shaft is not able to unscrew from the push-button because they are perdurably connected together. In addition to preventing the shaft from separating from the push-button, embodiments of the present invention allow for overall length adjustment by using a novel nested cylindrical housing design.

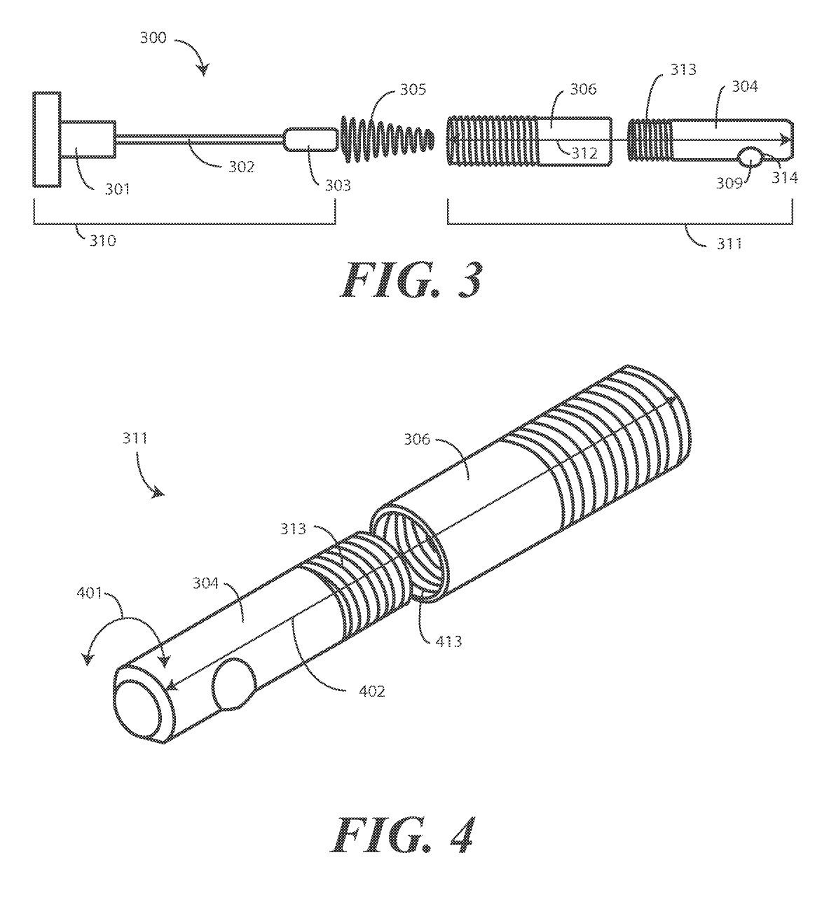

Turning now to FIG. 3, illustrated therein is an exploded view of one explanatory mechanical retention apparatus configured in accordance with one or more embodiments of the invention. In the illustrative embodiment of FIG. 3, the mechanical retention apparatus is a leg rest release 300 configured for use with a wheelchair. In one embodiment, the wheelchair is a pediatric wheelchair. The primary components of leg rest release 300 of FIG. 3 are a unitary shaft-stem assembly 310 having a push-button 301, shaft 302, and stem 303. The shaft 302 is perdurably connected to both the push-button 301 and the stem 303 so as to form a unitary, single component.

In one embodiment, the shaft 302, which can be manufactured from metal in one embodiment, is perdurably connected to the push-button 301 by insert molding. Where this is the case, the push-button 301 can be manufactured from a thermoplastic or resin. In an insert molding process, the shaft 302, and optionally the stem 303, are placed into a mold. The thermoplastic or resin is then injected into the mold about the stem 303, thus forming a unitary, perdurably connected component. Where both the shaft 302 and the push-button 301 are manufactured from thermoplastics, they can, of course, be molded as a singular, non-separable component.

In another embodiment, both the push-button 301 and the shaft 302 can be manufactured from metal. Accordingly, the push-button 301 and the shaft 302 can be perdurably connected via a welding process, soldering process, or other metal adhesion process. Similarly, where the stem 303 and shaft 302 are manufactured from separate selections of metal, the stem 303 and shaft 302 can be perdurably connected by welding, soldering or other metal adhesion process. Alternatively, the stem 303 and shaft 302 can be manufactured from a single piece of metal, thereby eliminating any connection point between the two components.

In yet another embodiment, the shaft 302 and push-button 301 can be perdurably connected together by way of epoxy or other permanent adhesive component. In yet another embodiment, the shaft 302 and push-button 301 can be perdurably connected together by pinning, riveting, crimping, or otherwise permanently affixing the two components together. The perdurable connecting methods described are illustrative only, as others will be obvious to those of ordinary skill in the art having the benefit of this disclosure.

A spring 305, which is geometrically configured to be conical in the illustrative embodiment of FIG. 3, biases the unitary shaft-stem assembly 310 out of a first cylindrical housing 306. Said differently, in one embodiment, the spring 305 is configured to configured to bias the unitary shaft-stem assembly 310 in a direction running along the axial center of the nested cylindrical housing assembly 311. The direction is to the left as shown in FIG. 3.

A second cylindrical housing 304, which has a diameter that is less than that of the first cylindrical housing 306 in this illustrative embodiment, nests within the first cylindrical housing 306 to form a nested cylindrical housing assembly 311 via a threaded end 313. An axial length 312 of the nested cylindrical housing assembly 311 can be selectively adjusted by rotating the second cylindrical housing 304 into or out of the first cylindrical housing 306. While the second cylindrical housing 304 is shown as having the smaller diameter, note that in another embodiment the opposite could be true, with the first cylindrical housing having 206 having a diameter that is less than that of the second cylindrical housing 304 so as to nest within the second cylindrical housing via a threaded component disposed at the end of the first cylindrical housing 306.

A ball bearing 309 disposed in the second cylindrical housing 304 is selectively allowed to translate into and out of the second cylindrical housing 304 in a direction that is orthogonal to the central axis defined by the first cylindrical housing 306 and the second cylindrical housing 304. Note that while the ball bearing 309 is shown being disposed in the second cylindrical housing 304 in FIG. 3, it could equally be disposed in the first cylindrical housing 306 by placing the aperture 314 in the first cylindrical housing 306. Accordingly, the ball bearing 309 can be disposed within one of the first cylindrical housing 306 or the second cylindrical housing 304.

The central axis of FIG. 3 would be substantially aligned with the shaft 302 of the unitary shaft-stem assembly 310. When the unitary shaft-stem assembly 310 is pressed into the nested cylindrical housing assembly 311, thereby compressing the spring 305, the stem 303 translates to the right (as viewed in FIG. 3), thereby slipping past the ball bearing 309 and allowing the ball bearing 309 to translate into the second cylindrical housing 304. Releasing the push-button allows the spring 305 to bias the unitary shaft-stem assembly back to the left (as viewed in FIG. 3), thereby bringing the stem 303 into vertical (as viewed in FIG. 3) alignment with the ball bearing 309. Accordingly, the ball bearing 309 is forced to translate outwardly from the central axis into an aperture 314 with a diameter that is less than that of the ball bearing 309. Said differently, the stem 303 is configured to bias the ball bearing 309 out of the second cylindrical housing 304 through the aperture 314 when the spring 305 is in a rest position, i.e., when the push-button 301 is released. The ball bearing 309 thus partially protrudes from the second cylindrical housing 304, thereby forming a mechanical latch that nests within a détente disposed in the wheelchair. By contrast, the stem 303 is configured to permit the ball bearing 309 to retract within the second cylindrical housing 304 when the spring 305 is compressed, i.e., when the push-button is pressed towards the nested cylindrical housing assembly 311.

The “axial length adjustability” of the nested cylindrical housing assembly 311 can be more readily appreciated using the view of FIG. 4. Turning now to FIG. 4, first cylindrical housing 306 and the second cylindrical housing 304 can be seen in a perspective view. As shown, the first cylindrical housing 306 forms a female housing of the nested cylindrical housing assembly 311, and has interior threads 413 disposed at a first end of the first cylindrical housing 306. The second cylindrical housing 304 forms a male housing of the nested cylindrical housing assembly 311 and has complementary threads on its threaded end 313. The complementary threads engage the interior threads 413 such that the second cylindrical housing 304 can be rotated 401 into, or out of, the first cylindrical housing 306 to adjust the axial length 402 of the nested cylindrical housing assembly 311. Since the axial length 402 of the nested cylindrical housing assembly 311 by rotating the two cylindrical housings relative to each other, there is no need for the length of the unitary shaft-stem assembly (310) to change. When the axial length 402 is altered by rotating the two cylindrical housings, the spring (305) keeps the unitary shaft-stem assembly (310) properly biased out of a second end of the first cylindrical housing 306 such that the stem (303) can be engaged with the ball bearing (309).

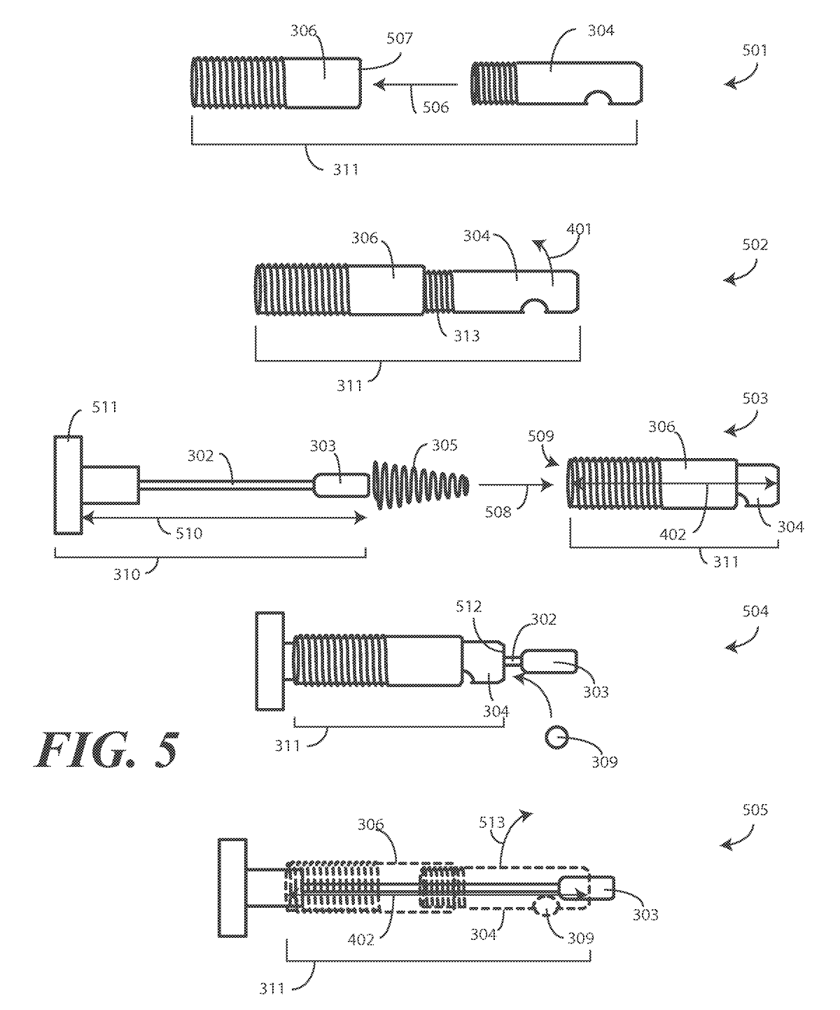

Turning now to FIG. 5, illustrated therein is a method of assembling a leg rest release in accordance with one or more embodiments of the invention. At step 501, the second cylindrical housing 304 is inserted 506 into a first end 507 of the first cylindrical housing 306 to form the beginning structure of the nested cylindrical housing assembly 311. At step 502, the second cylindrical housing 304 is rotated 401. This causes the threaded end 313 of the second cylindrical housing 304 to engage the interior threads (413) of the first cylindrical housing 306. Once engaged, the nested cylindrical housing assembly 311 is formed.

At step 503, the spring 305 is inserted into a second end 509 of the first cylindrical housing 306. The unitary shaft-stem assembly 310 is then inserted into the second end 509 of the first cylindrical housing 306 through an axial center of the spring 305 such that the shaft 302 and stem 303 pass through an interior of the spring 305. In this illustrative embodiment, the second cylindrical housing 304 has been rotated into the first cylindrical housing 306 to a maximum extent such that the axial length 402 of the nested cylindrical housing assembly 311 is at its minimum.

In one embodiment, the minimum of the axial length 402 is less than an axial length 510 of the unitary shaft-stem assembly 310 extending from just below a push surface 511 of the push-button to the end of the stem 303. This is shown at step 504, where the unitary shaft-stem assembly 310 has been fully inserted into the nested cylindrical housing assembly 311, thereby compressing the spring 305 such that the stem 303 protrudes from an end of the nested cylindrical housing assembly 311. Accordingly, the unitary shaft-stem assembly 310 is disposed along an axial center of the nested cylindrical housing assembly 311. This “full insertion” occurs when the minimum of the axial length 402 is less than an axial length 510 of the unitary shaft-stem assembly 310 causes the stem 303 and a portion of the shaft 302 to extend beyond a second end 512 of the second cylindrical housing 304, thereby allowing the ball bearing 309 to be inserted between the walls of the second cylindrical housing 304 and the shaft 302. Said differently, the ball bearing 309 passes by the shaft end of the stem 303 into the second cylindrical housing 304.

When the unitary shaft-stem assembly 310 is released, the spring 305 causes the stem 303 to retract into the second cylindrical housing 304 by biasing the push-button outwardly from the nested cylindrical housing assembly 311, thereby retaining the ball bearing 309 within the second cylindrical housing 304. This is shown in step 505, where the stem 303 retains the ball bearing 309 within the second cylindrical housing 304. Once the unitary shaft-stem assembly 310 is release, the second cylindrical housing 304 can be un-rotated 513 from the first cylindrical housing 306 to adjust the axial length 402 of the nested cylindrical housing assembly 311 to a length appropriate for its application, i.e., for an appropriate length corresponding to the particular wheelchair into which it is to be inserted.

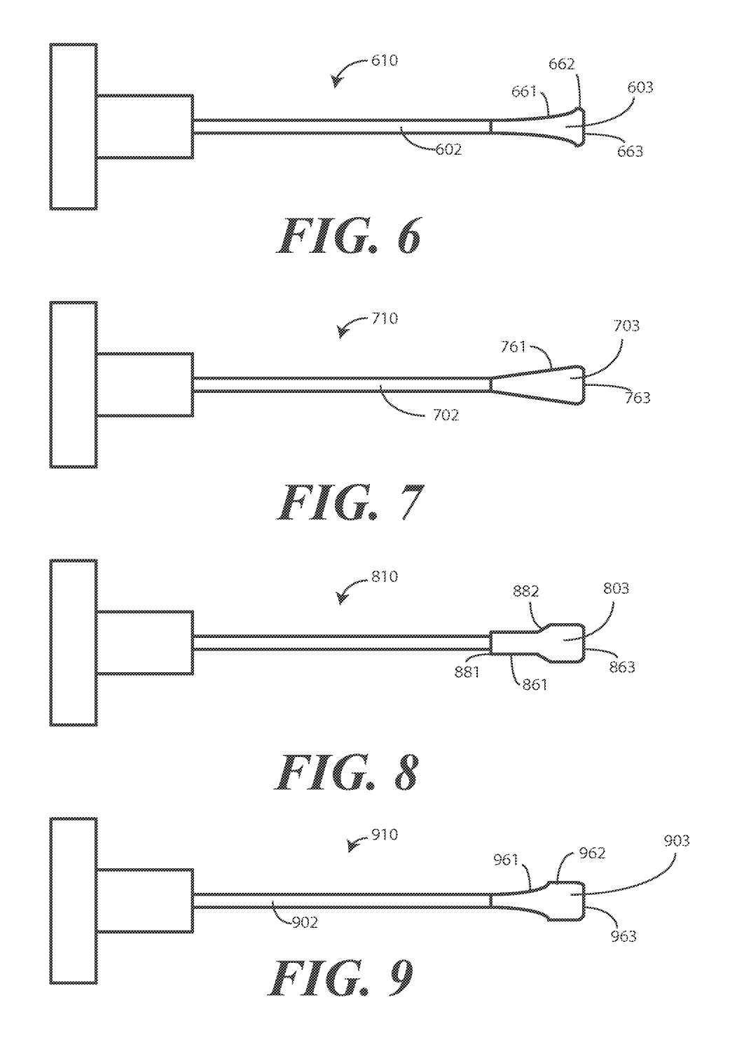

Turning now to FIGS. 6-9, illustrated therein are alternate unitary shaft-stem assemblies configured in accordance with one or more embodiments of the invention. FIGS. 6-9 are included to illustrate some of the different stem configurations that are suitable for use with various embodiments of the invention. The explanatory embodiments shown in FIGS. 6-9 are illustrative only, as others will be obvious to those having ordinary skill in the art and benefit of this disclosure. Further, while a consistent push-button configuration is shown in FIGS. 6-9, it is to be understood that the push-button can take a variety of different geometries without departing from the spirit and scope of the embodiments described herein.

Beginning with FIG. 6, illustrated therein is a unitary shaft-stem assembly 610 having a concave, curvilinear stem 603. (Note that the unitary shaft-stem assembly (310) of FIGS. 1-2 had a form of convex, curvilinear stem.) Specifically, the concave, curvilinear stem 603 has concave curvatures 661 that begin at the shaft 602 and taper outwardly from the shaft 602 to an angular engagement line 662. The angular engagement line 662 extends back in towards the axial center of the unitary shaft-stem assembly 610 to a stem base 663.

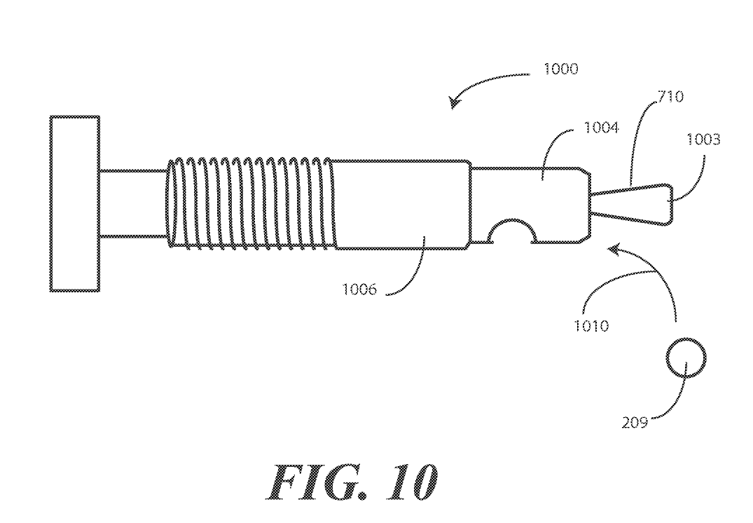

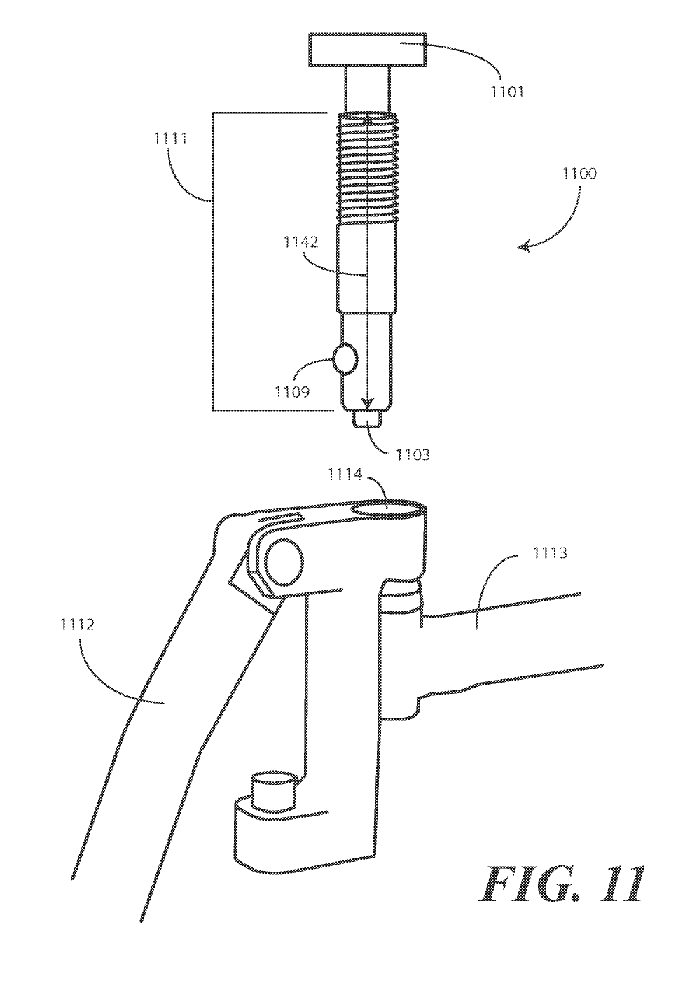

Turning to FIG. 7, the unitary shaft-stem assembly 710 illustrated therein includes a linearly expanding stem 703. The linearly expanding stem 703 includes linear sides 761 that extend outwardly from the shaft 702 and terminate at a stem base 763. Turning briefly to FIG. 10, a leg rest release 1000 using the unitary shaft-stem assembly 710 of FIG. 7 is shown at an equivalent of step (504) of FIG. 5 where the ball bearing 309 is being inserted into the second cylindrical hosing 1004. An advantage of the linearly expanding stem 703 is that the second cylindrical housing 1004 need not be rotated as far into the first cylindrical housing 1006 as was the case when the convex, curvilinear stem of FIG. 5 was used. The same is true of each of the stems shown in FIGS. 6-9, i.e., the amount of rotation of each of the cylindrical housings into each other can be reduced.

Turning to FIG. 8, the unitary shaft-stem assembly 810 illustrated therein includes a plural-step expanding stem 803. The plural-step expanding stem 803 has a stair-step 881 at the shaft interface, followed by sidewalls 861 that extend in a generally parallel fashion with the axial center of the unitary shaft-stem assembly 810. Then, linearly sides 882 extend outwardly from the axial center and run to a second set of sidewalls 862 that also run in a generally parallel fashion with the axial center of the unitary shaft-stem assembly 810. The second set of sidewalls 862 terminate at a stem base 863.

Turning to FIG. 9, the unitary shaft-stem assembly 910 has a hybrid concave-linear stem 903. The hybrid concave-linear stem 903 has concave curvatures 961 that begin at the shaft 902 and taper outwardly from the shaft 902 to linear sidewalls 962 that run substantially parallel with the axial center of the shaft 902 to a stem base 963.

Turning to FIG. 11, illustrated therein is one explanatory leg rest release 1100 being used in practice. FIG. 11 also illustrates a method of using one explanatory leg rest release 1100 in accordance with one or more embodiments of the invention.

As shown, a leg rest 1112 has been attached to a wheelchair 1113. An aperture 1114 is defined between the leg rest 1112 and the wheelchair 1113. The explanatory leg rest release 1100 is configured for insertion into the aperture 1114.

After rotating the first cylindrical housing 1106 relative to the second cylindrical housing 1104 to create the appropriate axial length 1142 of the nested cylindrical housing assembly 1111, a user first presses the push-button 1101 into the explanatory leg rest release 1100, thereby causing the stem 1103 to extend beyond the second cylindrical housing 1104. This permits the ball bearing 1109 to withdraw into the second cylindrical housing 1104. The explanatory leg rest release 1100 is then inserted into the aperture 1114. Once seated, the user may release the push-button 1101, thus retracting the stem 1103 into the second cylindrical housing 1104 due to a loading force of the spring (not shown) disposed in the first cylindrical housing 1106. The ball bearing 1109 is thus forced outwardly from the second cylindrical housing 1104 and engages a détente in the wheelchair 1113, thereby holding the leg rest 1112 securely against the wheelchair 1113.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A mechanical retention apparatus, comprising:
a first cylindrical housing and a second cylindrical housing, the first cylindrical housing having internal threads, the second cylindrical housing having a threaded end that is complementary with the internal threads such that the internal threads and the threaded end can engage to form a nested cylindrical housing assembly; and
a unitary shaft-stem assembly comprising a push-button, a stem, and a shaft, wherein the shaft is perdurably connected to the push-button;
wherein the unitary shaft-stem assembly is disposed along an axial center of the nested cylindrical housing assembly.

2. The mechanical retention apparatus of claim 1, further comprising a spring configured to bias the unitary shaft-stem assembly in a direction running along the axial center.

3. The mechanical retention apparatus of claim 2, further comprising a ball bearing disposed within one of the first cylindrical housing or the second cylindrical housing, wherein the stem is configured to bias the ball bearing out of the one of the first cylindrical housing or the second cylindrical housing through an aperture of the one of the first cylindrical housing or the second cylindrical housing when the spring is in a rest position.

4. The mechanical retention apparatus of claim 3, wherein the stem is configured to permit the ball bearing to retract within the one of the first cylindrical housing or the second cylindrical housing when the spring is compressed.

5. The mechanical retention apparatus of claim 4, wherein the stem comprises a convex, curvilinear stem.

6. The mechanical retention apparatus of claim 4, wherein the stem comprises a concave, curvilinear stem.

7. The mechanical retention apparatus of claim 4, wherein the stem comprises linear expanding stem.

8. The mechanical retention apparatus of claim 4, wherein the stem comprises a plural-step expanding stem.

9. The mechanical retention apparatus of claim 4, wherein the stem comprises a hybrid concave-linear stem.

10. The mechanical retention apparatus of claim 1, wherein an axial length of the nested cylindrical housing assembly is configured to be adjustable by rotation of the first cylindrical housing relative to the second cylindrical housing.

11. The mechanical retention apparatus of claim 1, wherein the mechanical retention apparatus comprises a wheelchair leg rest release.

12. A method of assembling a mechanical retention apparatus, comprising:
inserting a first cylindrical housing into a second cylindrical housing;
rotating the first cylindrical housing relative to the second cylindrical housing to engage a threaded end of the first cylindrical housing with complementary internal threads of the second cylindrical housing to form a nested cylindrical housing assembly; and
inserting a unitary shaft-stem assembly into the nested cylindrical housing assembly, wherein the unitary shaft-stem assembly comprises a push-button, a stem, and a shaft, with the shaft perdurably connected to the push-button.

13. The method of claim 12, wherein the rotating comprises rotating the second cylindrical housing to a maximum extent such that an axial length of the nested cylindrical housing assembly is at its minimum.

14. The method of claim 12, further comprising inserting a spring into the nested cylindrical housing assembly prior to the inserting.

15. The method of claim 14, further comprising pressing the push-button towards the nested cylindrical housing assembly, thereby compressing the spring, such that the stem protrudes from an end of the nested cylindrical housing assembly.

16. The method of claim 15, further comprising inserting a ball bearing into the end of the nested cylindrical housing assembly.

17. The method of claim 16, further comprising releasing the push-button, thereby allowing the stem to retain the ball bearing within the nested cylindrical housing assembly when the spring biases the push-button outwardly from the nested cylindrical housing assembly.

18. The method of claim 17, further comprising un-rotating the first cylindrical housing relative to the second cylindrical housing to adjust an axial length of the nested cylindrical housing assembly to a predetermined length.

19. A method of using a mechanical retention device, comprising:
rotating a first cylindrical housing relative to a second cylindrical housing to create a predetermined axial length of a nested cylindrical housing assembly;
pressing a push-button of a unitary shaft-stem assembly into the nested cylindrical housing assembly, wherein the unitary shaft-stem assembly comprises a stem and a shaft, with the shaft perdurably connected to the push-button;
wherein the pressing results in the stem extending beyond the second cylindrical housing, thereby permitting a ball bearing disposed within the second cylindrical housing to withdraw into the second cylindrical housing.

20. The method of claim 19, further comprising:
inserting the mechanical retention device into an aperture defined between a leg rest assembly and a wheelchair; and
releasing the push-button, thereby retracting the stem into the second cylindrical housing and forcing the ball bearing outwardly from the second cylindrical housing to engage a détente in the wheelchair.
